(19) United States
(12) Patent Application Publication
(10) Pub. No.: US 2024/0233678 A1
(43) Pub. Date: Jul. 11, 2024

(54) CONTROL METHOD, APPARATUS, AND STORAGE MEDIUM

(71) Applicant: CANON KABUSHIKI KAISHA, Tokyo (JP)

(72) Inventor: TAKUYA TAKENOUCHI, Kanagawa (JP)

(21) Appl. No.: 18/409,580

(22) Filed: Jan. 10, 2024

(30) Foreign Application Priority Data
Jan. 11, 2023 (JP) 2023-002115

(51) Int. Cl. G09G 5/00

(52) U.S. Cl. CPC G09G 5/00; G06F 3/1208; G09G 2320/0666; G09G 2320/0686; G09G 2320/08; G09G 2340/06; G09G 2354/00

(57) ABSTRACT

A control method includes generating content data to include display setting information, wherein the content data is generated by an information processing apparatus and the display setting information being setting information about a display of the information processing apparatus, and displaying the content data based on the display setting information corresponding to the content data.

### BACKGROUND

### Field of the Disclosure

The present disclosure relates to an information processing apparatus, a control method of the information processing apparatus, and a storage medium.

### Description of the Related Art

Products for creating layout data, such as photo album data and poster data, by laying out a plurality of images on a plane of paper using a layout data creation application have been released in recent years. To create more attractive layout data by a plurality of users, the application typically can output layout data created by one user as an external file to share the file with another user. The receiving user can open the file using the application, and check and edit the layout data.

Terminals, such as a personal computer (PC), a tablet terminal, and a smartphone, and the application have a function of reducing blue light and a function of setting a color profile to be used in a display device such as a display monitor. Using such functions, the user can freely change display settings, such as display color, on the display device according to his/her own preferences. A user using a plurality of terminals and applications makes settings by himself/herself each time to make the display settings of all the terminals and applications the same.

Japanese Patent No. 6701301 discusses a technique for displaying an operation screen of an image processing apparatus in a user-desired display format when the user accesses the image processing apparatus via a network.

However, if the user who creates layout data and the user who displays the created layout data are different, the same layout data can appear in different colors depending on the display settings of the terminals or applications. This can interfere with appropriate color check. The users can check each other's display settings and manually change the display settings to display the layout data, whereas such a display setting change operation is quite cumbersome.

### SUMMARY

Aspects of the present disclosure provide a mechanism for facilitating display of content data such as layout data with the same display settings as those used when the content data is created.

According to an aspect of the present disclosure, a control method includes generating content data to include display setting information, wherein the content data is generated by an information processing apparatus and the display setting information being setting information about a display of the information processing apparatus, and displaying the content data based on the display setting information corresponding to the content data.

Further features of the present disclosure will become apparent from the following description of embodiments with reference to the attached drawings.

### BRIEF DESCRIPTION OF THE DRAWINGS

FIG. 1 is a diagram illustrating a configuration of a system including an information processing apparatus demonstrating an embodiment.

FIGS. 2A and 2B are diagrams illustrating screens for setting user information.

FIGS. 3A and 3B are diagrams illustrating screens for making display-related settings.

FIG. 4 is a diagram illustrating a configuration of layout data created in the present embodiment.

FIG. 5 is a diagram illustrating a configuration of a file describing display setting information.

FIG. 6 is a diagram illustrating a configuration of a file describing user information about a creation user.

FIG. 7 is a diagram illustrating a screen displayed to create, edit, and display layout data.

FIG. 8 is a flowchart for describing layout data storage processing according to a first embodiment.

FIG. 9 is a flowchart for describing layout data display processing according to the first embodiment.

FIG. 10 is a flowchart for describing layout data display processing according to a second embodiment.

FIG. 11 is a diagram illustrating a screen for selecting whether to change display settings.

FIG. 12 is a flowchart for describing layout data display processing according to a third embodiment.

FIG. 13 is a screen for notifying of a failure in changing display settings.

FIG. 14 is a flowchart for describing layout data display processing according to a fourth embodiment.

FIG. 15 is a diagram illustrating a change presetting screen for presetting whether to change display settings during display.

FIG. 16 is a diagram illustrating a configuration of a file describing display setting information according to a fifth embodiment.

FIG. 17 is a flowchart for describing layout data storage processing according to the fifth embodiment.

FIG. 18 is a flowchart for describing layout data display processing according to the fifth embodiment.

FIG. 19 is a diagram illustrating a screen for presetting users to change the display settings of during display.

FIG. 20 is a diagram illustrating a configuration of a file describing display setting information according to a sixth embodiment.

FIG. 21 is a flowchart for describing layout data storage processing according to the sixth embodiment.

FIG. 22 is a flowchart for describing layout data display processing according to the sixth embodiment.

FIG. 23 is a diagram illustrating a screen for creating, editing, and displaying layout data according to a seventh embodiment.

FIG. 24 is a flowchart for describing layout data display processing according to the seventh embodiment.

FIG. 25 is a flowchart for describing layout data display end processing according to the seventh embodiment.

### DESCRIPTION OF THE EMBODIMENTS

Embodiments of the present disclosure will be described in detail below with reference to the drawings. The following embodiments are not intended to limit the present disclosure set forth in the claims, and all combinations of features described in the embodiments are not necessarily essential to the solving means of the present disclosure.

Content data such as layout data created by a user (hereinafter, “layout data”) can be displayed by another user. In other words, the user who creates layout data (hereinafter, referred to as a “creation user”) and the user who displays the layout data (hereinafter, referred to as a “display user”) can be different. An information processing apparatus according to a first embodiment can display layout data by adjusting the display settings of the display user to those of the creation user in such a case. As a result, the layout data can be displayed with the same display settings as those of the creation user even in a case where a user different from the creation user displays the layout data. Situations where the layout data appears in different colors depending on the display settings can thus be reduced.

The present embodiment will be described by using an operating system (OS)-settable night mode setting for reducing blue light as an example of the display settings. A function of reducing blue right typically makes the display device yellowish, and the color of the layout data displayed on the display device can be different. Note that the display settings according to the present embodiment are not limited to the foregoing night mode setting and include various display settings.

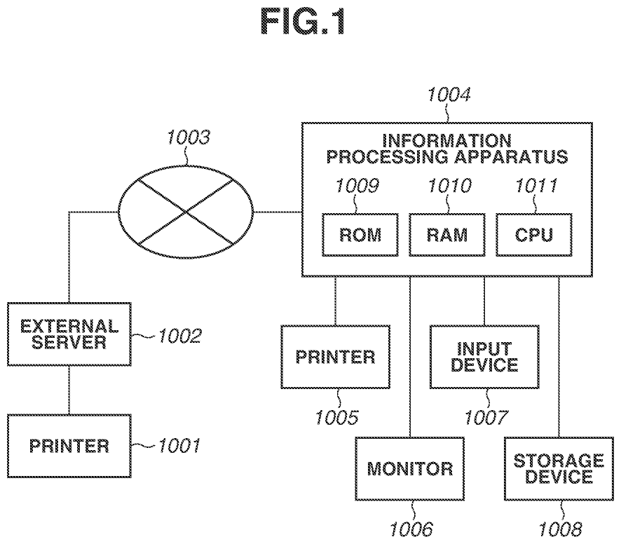

A configuration of an information processing apparatus 1004 according to the present embodiment will initially be described with reference to FIG. 1.

FIG. 1 is a diagram illustrating a configuration of a system including the information processing apparatus 1004 according to the present embodiment.

The information processing apparatus 1004 used in the present embodiment is assumed to be a personal computer and capable of creating layout data. The information processing apparatus 1004 can also output the created layout data as a file, output the created layout data as print data, and upload the created layout data to an external server. The information processing apparatus 1004 functions, for example, as a layout data editing apparatus for laying out a plurality of images captured by a digital camera on a plane of paper and editing layout data.

In the present embodiment, layout data is not limited to data used for a photo album or a poster where a plurality of images is laid out on a plane of paper. The layout data according to the present embodiment may include data where a plurality of images, text, and figures are laid out in combination, various types of design data, illustration data combining lines and figures, and various types of moving image data including animation data. The layout data according to the present embodiment includes all types of content data of which quality can be affected by color. The layout data according to the present embodiment is also referred to simply as “content data”.

The information processing apparatus 1004 includes a read-only memory (ROM) 1009, a random access memory (RAM) 1010, and a central processing unit (CPU) 1011. The information processing apparatus 1004 also includes various input/output interfaces (not illustrated) for connecting with a printer 1005, a monitor 1006, an input device 1007, a storage device 1008, and a network 1003.

The CPU 1011 controls the entire information processing apparatus 1004 by executing an OS stored in the storage device 1008, the ROM 1009, or the RAM 1010. The CPU 1011 also implements functional configurations of the information processing apparatus 1004, calculates and processes information, and controls pieces of hardware by executing various programs stored in the storage device 1008, the ROM 1009, and/or the RAM 1010.

The ROM 1009 stores programs and data. The RAM 1010 is used as a work memory of the CPU 1011.

The network 1003 is a communication network connected to apparatuses, such as the information processing apparatus 1004 and an external server 1002, and intended to transmit information about the connected apparatuses.

The external server 1002 includes an input/output interface (not illustrated) for connecting with a printer 1001, and is connected with the printer 1001. Layout data created in the information processing apparatus 1004 is uploaded to the external server 1002 via the network 1003. If the uploaded layout data is printable, the external server 1002 outputs the layout data to the printer 1001. For example, the external server 1002 is a layout data order entry and management server. A user uploads the layout data created on his/her own information processing apparatus 1004 to the external server 1002. When the user completes a predetermined purchase procedure, the external server 1002 outputs the uploaded layout data using the printer 1001. The output print product is then delivered to the user.

The printer 1005 is a printer for printing a print product based on the layout data created using the information processing apparatus 1004. Depending on the configuration, the user can print the created layout data with the user's own printer 1005 and finish the print product by himself/herself.

The monitor 1006 is a display device that displays image information output from the information processing apparatus 1004. For example, the monitor 1006 displays the layout data created by the user.

The input device 1007 is one intended to make an input to the information processing apparatus 1004. Examples include a keyboard and a pointing device. Depending on the configuration, the input device 1007 may be integrated with the monitor 1006 so that the user directly touches the monitor 1006 for input.

The storage device 1008 stores image data and templates. Examples include a hard disk drive (HDD), a solid-state drive (SSD), and an embedded MultiMediaCard (eMMC).

In the example of FIG. 1, the information processing apparatus 1004, the monitor 1006, the input device 1007, and the storage device 1008 are illustrated as separate devices. However, depending on the configuration of the information processing apparatus 1004, the devices may be integrated so that the information processing apparatus 1004 includes the monitor 1006, the input device 1007, and the storage device 1008 as its components. The storage device 1008 can also be shared with the RAM 1010 of the information processing apparatus 1004.

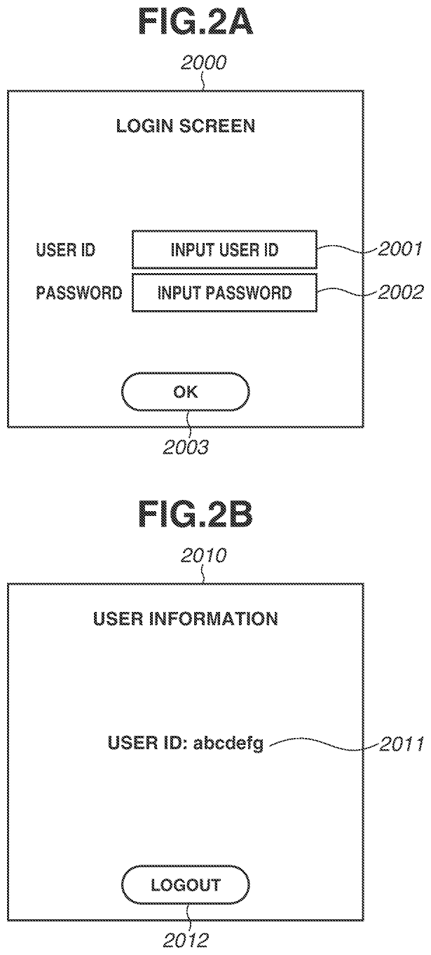

Next, screens for making settings related to user information, displayed by the information processing apparatus 1004 will be described with reference to FIGS. 2A and 2B.

FIGS. 2A and 2B are diagrams illustrating examples of the screens for setting the user information, provided by the OS.

FIG. 2A illustrates a user information setting screen 2000, which is a login screen displayed for the user to set user information by login. A user identifier (ID) input section 2001 is an input section where a user ID for setting the user information is input. In the present embodiment, the user ID is an ID for identifying the user. The user inputs a user ID of his/her own user information into the user ID input section 2001. A password input section 2002 is an input section where a password for setting the user information is input. The user inputs a password of his/her own user information into the password input section 2002.

When the user inputs the user ID and the password into the user ID input section 2001 and the password input section 2002 and presses an OK button 2203, the information processing apparatus 1004 performs predetermined authentication processing (not illustrated). If the authentication processing is normally completed, the information processing apparatus 1004 completes the setting of the user information.

FIG. 2B illustrates a user information display screen 2010, which is a screen displayed after the user information is set by the user. A user ID display section 2011 is a display section where the user ID of the user information set by the user is displayed. In the display example of the user ID display section 2011 in FIG. 2B, user information with a user ID of “abcdefg” is displayed to be set.

A logout button 2012 is a button for logging out to delete the user information set by the user. The user can log out by pressing the logout button 2012, whereby the user information set as described above is deleted.

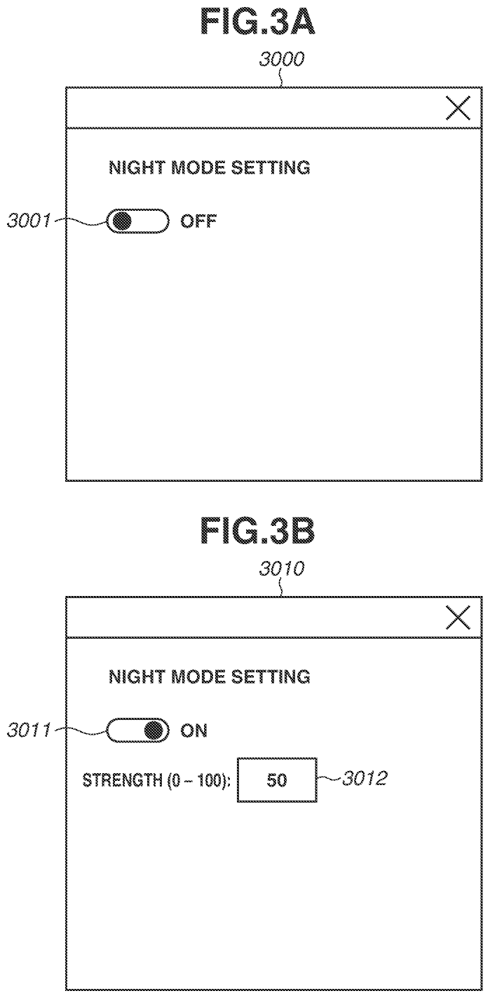

Next, screens for making display-related settings, displayed by the information processing apparatus 1004 will be described with reference to FIGS. 3A and 3B.

FIGS. 3A and 3B are screens for setting a night mode, provided by the OS.

FIG. 3A illustrates a setting screen 3000, which is a screen displayed if the night mode setting is off. The user can switch the night mode setting on and off by pressing a night mode setting button 3001 on the setting screen 3000.

FIG. 3B illustrates a setting screen 3010, which is a screen displayed if the night mode setting is on. The user can switch the night mode setting on and off by pressing a night mode setting button 3011 on the setting screen 3010.

A strength setting section 3012 is a setting section for setting the strength of blue light reduction in the night mode. The strength setting section 3012 can input a value in the range of 0 to 100, whereby the strength of the blue light reduction can be set.

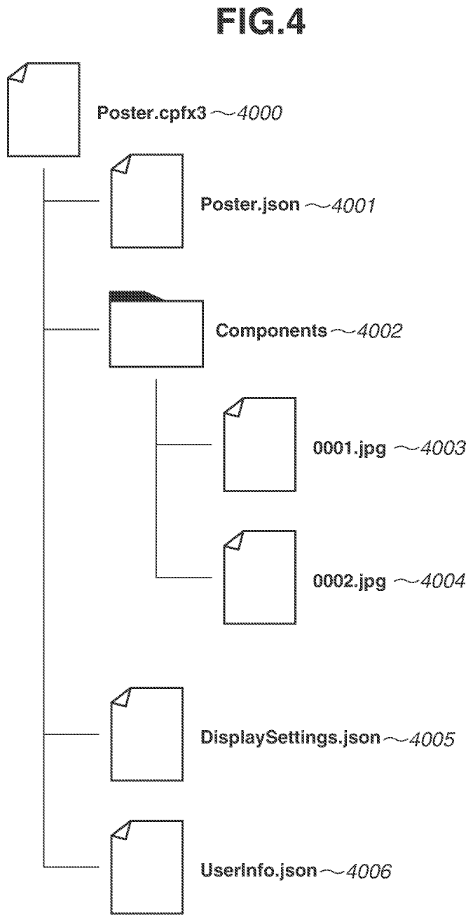

Next, a configuration of layout data created using the information processing apparatus 1004 will be described with reference to FIG. 4.

FIG. 4 is a diagram illustrating an example of the configuration of the layout data created in the present embodiment. This layout data is created using a screen for creating and editing layout data to be described below. In the present embodiment, the created layout data will be described by using a file having an extension cpfx3 as an example.

In FIG. 4, a file 4000 contains the created layout data. In the example of FIG. 4, the file 4000 has a filename “Poster.cpfx3”.

A file 4001 describes layout information about the created layout data. In the example of FIG. 4, the file 4001 has a filename “Poster.json”. As employed herein, a file with an extension json is described in JavaScript® Object Notation (JSON).

A folder 4002 contains images used in the created layout data. In the example of FIG. 4, the folder 4002 has a folder name “Components”.

An image 4003 is used in the created layout data. In the example of FIG. 4, the image 4003 has a filename “0001.jpg”. Similarly, an image 4004 is used in the created layout data. In the example of FIG. 4, the image 4004 has a filename “0002.jpg”.

A file 4005 describes information about the display settings (hereinafter, referred to as “display setting information”) in creating the layout data. In the example of FIG. 4, the file 4005 has a filename “DisplaySettings.json”.

A file 4006 describes information about the user who creates the layout data (hereinafter, referred to as “user information). In the example of FIG. 4, the file 4006 has a filename “UserInfo.json”.

The layout data is not limited to such a configuration, and may have any given configuration.

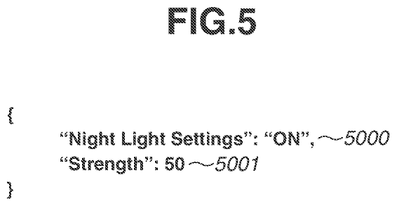

Next, the configuration of the file describing the display setting information (file 4005 in the example of FIG. 4) will be described with reference to FIG. 5.

FIG. 5 is a diagram illustrating an example of the file describing the display setting information in creating the layout data according to the present embodiment. In the present embodiment, the file describing the display setting information is a file with an extension json, for example, and described in JSON.

In FIG. 5, a key 5000 “Night Light Settings” describes whether the night mode setting is on or off. In the example of FIG. 5, the key 5000 “Night Light Settings” has a value “ON”, which indicates that the night mode setting is on.

A key 5001 “Strength” describes the set strength of the blue light reduction. In the example of FIG. 5, the key 5001 “Strength” has a value “50”, which indicates that the strength of the blue light reduction is set to 50.

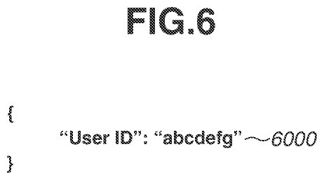

Next, a configuration of the file describing the user information about the user who creates the layout data (file 4006 in the example of FIG. 4) will be described with reference to FIG. 6.

FIG. 6 is a diagram illustrating an example of the file describing the user information about the user who creates the foregoing layout data. In the present embodiment, the file describing the user information is a file with an extension “json”, for example, and described in JSON.

In FIG. 6, a key 6000 “User ID” describes the user's ID. In the example of FIG. 6, the key 6000 “User ID” has a value “abcdefg”, which indicates that the user ID that is the ID of the user who creates the layout data is “abcdefg”.

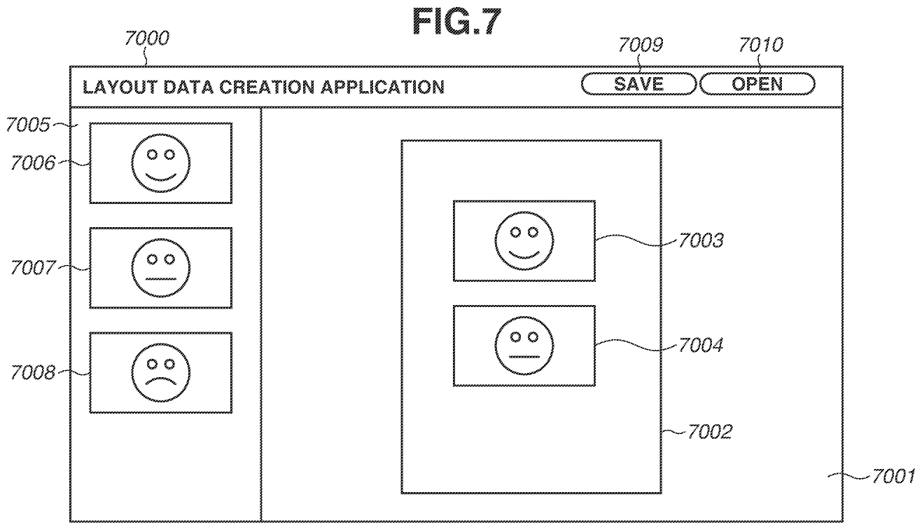

Next, a screen for creating, editing, and displaying layout data on the information processing apparatus 1004 will be described with reference to FIG. 7.

FIG. 7 is a diagram illustrating an example of the screen for creating, editing, and displaying layout data.

In FIG. 7, an editing screen 7000 is a screen for creating, editing, and displaying layout data. A layout data display section 7001 displays layout data being edited. Layout data 7002 being edited is displayed in the layout data display section 7001. In FIG. 7, images 7003 and 7004 are laid out on the layout data 7002.

An image list display section 7005 displays a list of images usable in editing the layout data 7002. The image list display section 7005 displays images 7006 to 7008 that can be laid out on the layout data 7002.

A save button 7009 is intended to store the created layout data into a file. If the user presses the save button 7009, the created layout data is output as a file with an extension “cpfx3” as illustrated in FIG. 4.

An open button 7010 is intended to open and display layout data stored in a file. If the user presses the open button 7010, the OS's file specification dialog (not illustrated) is displayed to accept file specification.

### Layout Data Storage Processing (Creation Processing)

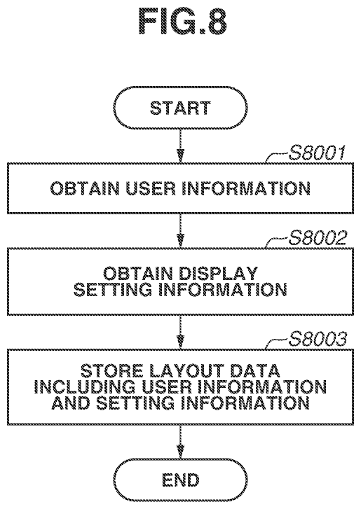

Next, processing for storing the layout data will be described with reference to FIG. 8.

FIG. 8 is a flowchart for describing layout data storage processing according to the first embodiment. The processing of this flowchart is implemented by the CPU 1011 reading a program stored in the storage device 1008 into the RAM 1010 and executing the program. The CPU 1011 of the information processing apparatus 1004 starts the processing of this flowchart if the save button 7009 of FIG. 7 is detected to be pressed.

In step S8001, the information processing apparatus 1004 initially obtains the user information about the user requesting the storage of the layout data. For example, the information processing apparatus 1004 is configured such that the user sets the user information by login from the user information setting screen 2000 such as illustrated in FIG. 2. In the processing of step S8001, the information processing apparatus 1004 obtains this user information (user information about the login user). If no user information has been set, the information processing apparatus 1004 may display the user information setting screen 200 at the timing of step S8001 to have the user set the user information. Specifically, in step S8001, the information processing apparatus 1004 obtains the user ID in the user information set by the user from the user information setting screen 2000. For example, if the user information is set as illustrated in FIG. 2B, then in step S8001, the information processing apparatus 1004 obtains the user ID “abcdefg” as the user information.

In step S8002, the information processing apparatus 1004 obtains display setting information about the user requesting the storage of the layout data. For example, the information processing apparatus 1004 is configured so that the user can set display setting information from the display setting screen 3000 such as illustrated in FIG. 3A. In the processing of step S8002, the information processing apparatus 1004 obtains this display setting information. The present embodiment is described by using the night mode setting as an example of the display settings. In the processing of step S8002, the information processing apparatus 1004 obtains the information about whether the night mode setting is on or off as display setting information. The information processing apparatus 1004 further obtains the information about the strength of the blue light reduction as display setting information. For example, if the night mode is set as illustrated in FIG. 3B, then in step S8002, the information processing apparatus 1004 obtains the night mode setting “ON” and the strength of the blue light reduction “50” as the display setting information.

In step S8003, the information processing apparatus 1004 includes the user information and the display setting information about the user who creates the layout data into the layout data, and stores the layout data. Details will now be described.

The information processing apparatus 1004 initially generates a file describing the user information such as illustrated in FIG. 6 based on the user information obtained in step S8001. For example, if the user ID “abcdefg” is obtained in step S8001, the information processing apparatus 1004 generates a file UserInfo.json described in JSON so that the key 6000 “User ID” has a value “abcdefg” as illustrated in FIG. 6.

Next, the information processing apparatus 1004 generates a file describing the display setting information such as illustrated in FIG. 5 based on the display setting information obtained in step S8002. If the night mode setting “ON” and the strength of the blue light reduction “50” are obtained as the display setting information in step S8002, the information processing apparatus 1004 generates a file DisplaySettings.json described in JSON such that the key 5000 “Night Light Settings” has a value “ON” and the key 5001 “Strength” has a value “50” as illustrated in FIG. 5.

Next, the information processing apparatus 1004 stores the layout data created by the user on the editing screen such as illustrated in FIG. 7 into a file Poster.cpfx3 as the layout data illustrated in FIG. 4. Here, the information processing apparatus 1004 includes the file UserInfo.json (file 4006 in FIG. 4 the) and the file DisplaySettings.json (file 4005 in FIG. 4 the) into the file Poster.cpfx3.

In such a manner, the layout data having the data configuration illustrated in FIG. 4 can be stored.

### Layout Data Display Processing

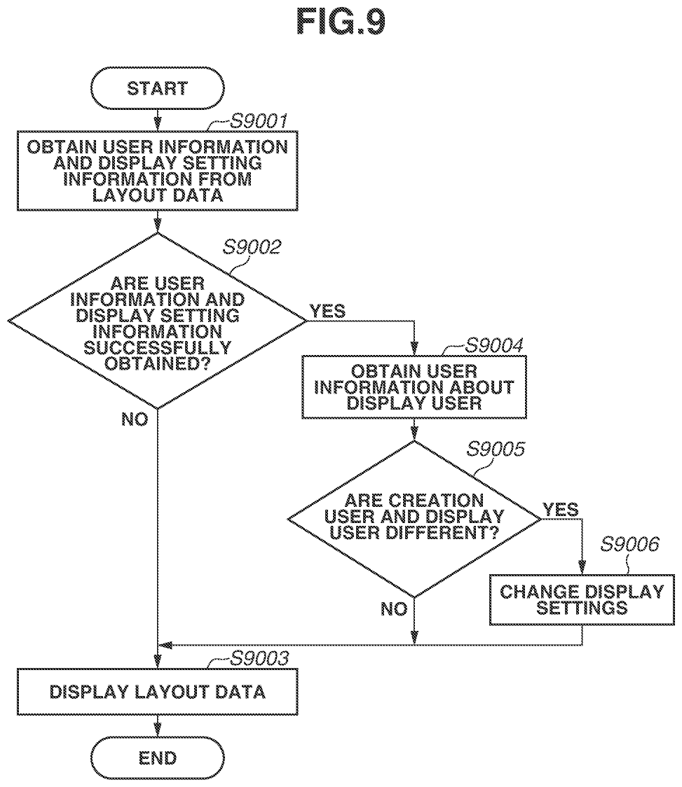

Next, processing for displaying the layout data stored in the file will be described with reference to FIG. 9.

FIG. 9 is a flowchart for describing layout data display processing according to the first embodiment. The processing of this flowchart is implemented by the CPU 1011 reading and executing a program stored in the storage device 1008 into the RAM 1010. The CPU 1011 of the information processing apparatus 1004 starts the processing of this flowchart if the open button 7010 of FIG. 7 is pressed and file specification is accepted via the OS's file specification dialog (not illustrated).

In step S9001, the information processing apparatus 1004 obtains the user information and the display setting information from the specified file of the layout data. As illustrated in FIG. 4, the file of the layout data includes the file UserInfo.json describing the user information and the file DisplaySettings.json describing the display setting information. Details will now be described.

The information processing apparatus 1004 initially obtains the file UserInfo.json (file 4006 in the example of FIG. 4) describing the user information from the file of the layout data (Poster.cpfx3 in the example of FIG. 4), and obtains the content of the file as the user information. As illustrated in FIG. 6, the file UserInfo.json describing the user information contains a JSON description of the user information. The user's ID is set as the value of the key 6000 “User ID”. Suppose, for example, that the file UserInfo.json describing the user information has the content illustrated in FIG. 6. In such a case, the information processing apparatus 1004 obtains the user's ID “abcdefg” as the user information about the user who creates the layout data.

Next, the information processing apparatus 1004 obtains the file DisplaySettings.json describing the display setting information from the file of the layout data (Poster.cpfx3 in the example of FIG. 4), and obtains the content of the file as the display setting information. As illustrated in FIG. 5, the file DisplaySettings.json describing the display setting information contains a JSON description of the display setting information. Whether the night mode setting is on or off is set as the value of the key 5000 “Night Light Settings”. Similarly, the strength is set as the value of the key 5001 “Strength”. Suppose, for example, that the file DisplaySettings.json describing the display setting information has the content illustrated in FIG. 5. In such a case, the information processing apparatus 1004 obtains the night mode setting “ON” and the strength “50” as the display setting information about the creation user.

In step S9002, the information processing apparatus 1004 determines whether the user information and the display setting information are successfully obtained from the specified file of the layout data.

If at least either the user information or the display setting information is not successfully obtained (NO in step S9002), the processing proceeds to step S9003.

In step S9003, the information processing apparatus 1004 displays the specified layout data on the editing screen 7000. More specifically, the information processing apparatus 1004 displays the editing screen 7000 such as illustrated in FIG. 7, and displays the specified layout data in the layout data display section 7001.

In contrast, if the user information and the display setting information are successfully obtained (YES in step S9002), the processing proceeds to step S9004.

In step S9004, the information processing apparatus 1004 obtains user information about the user requesting the display of the layout data. For example, the information processing apparatus 1004 is configured such that the user sets the user information by login from the user information setting screen 2000 such as illustrated in FIG. 2A. In the processing of step S9004, the information processing apparatus 1004 obtains this user information (user information about the login user). If no user information has been set, the information processing apparatus 1004 may display the user information setting screen 2000 at the timing of step S9004 to have the user set the user information. Specifically, in step S9004, the information processing apparatus 1004 obtains the user ID in the user information set by the user from the user information setting screen 2000.

In step S9005, the information processing apparatus 1004 determines whether the user who creates the layout data and the user who displays the layout data are different.

If the users are the same (NO in step S9005), the processing proceeds to step S9003.

In contrast, if the users are different (YES in step S9005), the processing proceeds to step S9006. For example, suppose that the user information about the creation user obtained from the layout data in the foregoing step S9001 is the user ID “abcdefg”. Suppose also that the set user information obtained in the foregoing step S9004 is user ID “hijklmn”. In such a case, the information processing apparatus 1004 determines that the user who creates the layout data and the user who displays the layout data are different, and the processing proceeds to step S9006.

In step S9006, the information processing apparatus 1004 changes the display settings based on the display setting information obtained from the layout data in the foregoing step S9001. In other words, the information processing apparatus 1004 changes the display settings of the display user based on the display setting information about the creation user of the layout data. For example, if the display setting information about the creation user indicates that the night mode setting is ON and the strength is set to 50, the information processing apparatus 1004 makes the settings on the OS. The resulting display settings of the display user are the night mode setting ON and the strength 50, the same as the display settings of the creation user. When the information processing apparatus 1004 subsequently displays the specified layout data on the editing screen 7000 in step S9003, the layout data is displayed with the same display settings as those of the creation user.

As described above, in the first embodiment, if a user outputs created layout data, another user displays the layout data, and the user who creates the layout data (creation user) and the user who displays the layout user (display user) are different, the layout data is displayed by adjusting the display settings of the display user to those of the creation user. This enables display under the same condition even if the user different from the creation user displays the editing data (layout data). Situations where the color changes depending on the display settings can thus be reduced.

In the present embodiment, the display settings have been described by using the OS-settable night mode setting for reducing blue light as an example. However, this is not restrictive. For example, if a color profile applied to a display device such as the monitor 1006 is settable by the user and the applied color profiles are different, the layout data can be displayed in different colors. The display setting information may therefore be setting information about the color profile set for display purposes. In other words, the display setting information may be information about the color space where the layout data is created.

If, for example, different display devices such as monitors are used, the layout data can be displayed in different colors depending on the device type (model) of the display device. The display setting information may therefore be information about the device type of the display device.

With such a configuration, the editing data can be displayed under the same condition even if a user different from the creation user displays the editing data. Color changes due to the display settings can thus be reduced.

The foregoing description of the layout data display processing of FIG. 9 has dealt with a configuration for changing the display settings based on the display settings of the creation user if the user who creates the layout data and the user who displays the layout data are different. However, a configuration for changing the display settings based on the display settings of the creation user without determining whether the user who creates the layout data and the user who displays the layout data are different in the layout data display processing is also included in the present embodiment. In the case of such a configuration, in step S9002 of FIG. 9, the information processing apparatus 1004 determines whether the display setting information is successfully obtained. If the display setting information is not successfully obtained, the processing proceeds to step S9003. With such a configuration, the layout data can be displayed with the display settings used in creating the layout data regardless of the display user.

Such a configuration enables the creation user to display his/her own layout data with the display settings used in creating the layout data even if the creation user has changed the display settings after the creation of the layout data.

Color check has conventionally been performed through complicated operations including the creation user and the display user checking each other's display settings, matching all the display settings, and displaying the layout data. By contrast, according to the present embodiment, the layout data can be displayed with the display settings of the display user automatically changed based on the display settings of the creation user as described above. This can significantly improve the usability in displaying the layout data.

In the foregoing first embodiment, if a user outputs created layout data, another user displays the layout data, and the creation user and the display user are different, the display settings of the display user are adjusted to those of the creation user. In a second embodiment, a method for changing the display settings of only the layout data display section for displaying layout data in adjusting the display settings of the display user to those of the creation user will be described. With such a configuration, even if a user different from the creation user displays editing data, the layout data can be displayed under the same condition while maintaining the display settings of the display user. Color changes due to the display settings can thereby be reduced. Only differences between the first and second embodiments will be described.

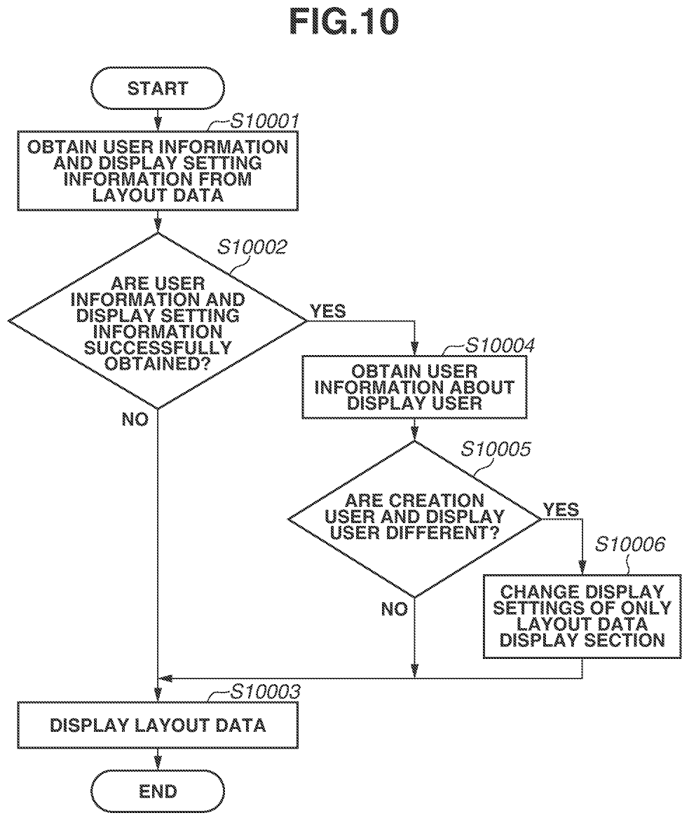

Processing for displaying layout data stored in a file will initially be described with reference to FIG. 10.

FIG. 10 is a flowchart for describing layout data display processing according to the second embodiment. The processing of this flowchart is implemented by the CPU 1011 reading a program stored in the storage device 1008 into the RAM 1010 and executing the program. The CPU 1011 of the information processing apparatus 1004 starts the processing of this flowchart if the open button 7010 of FIG. 7 is pressed and file specification is accepted via the OS's file specification dialog (not illustrated).

Steps S10001 to S10005 of FIG. 10 are similar to steps S9001 to S9005 of FIG. 9. A description thereof will thus be omitted. In the second embodiment, if the creation user and the display user are different (YES in step S10005), the processing proceeds to step S10006.

In step S10006, the information processing apparatus 1004 changes the display user's display settings of only the layout data display section based on the display setting information about the creation user, obtained from the layout data in step S10001. Specifically, suppose that the display setting information about the creation user, obtained in step S10001 indicates that the night mode setting is ON and the strength is set to 50. The information processing apparatus 1004 instructs the OS to apply the settings to only the layout data display section 7001. As a result, the display settings only in the area of the layout data display section 7001 provided to the display user are changed such that the night mode setting is ON and the strength is 50. The display settings of the layout data display section 7001 thus become the same as those of the creation user. When the information processing apparatus 1004 subsequently displays the specified layout data on the editing screen 7000 in step S10003, the layout data is thus displayed with the same display settings as those of the creation user.

As described above, in the second embodiment, the display settings of only the layout data display section 7001 for displaying the layout data are changed in adjusting the display settings of the display user to those of the creation user. As a result, even if a user different from the creation user displays the editing data, the layout data can be displayed under the same condition while maintaining the display settings of the display user. Color changes due to the display settings can thus be reduced.

In the foregoing first embodiment, if a user outputs created layout data, another user displays the layout data, and the creation user and the display user are different, the display settings of the display user are adjusted to those of the creation user. In a third embodiment, a method for having the display user select whether to change and adjust the display settings of the display user to those of the creation user will be described. With such a configuration, if a user different from the creation user displays the editing data, the display user can give priority to his/her own display settings. In addition, the display user can recognize that the layout data is created with different display settings, and recognize the possibility of color changes. Only differences between the first and third embodiments will be described.

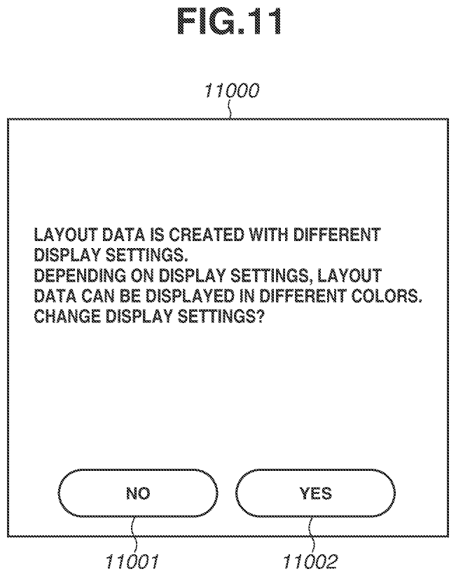

A screen for selecting whether to change the display settings will initially be described with reference to FIG. 11.

FIG. 11 is a diagram illustrating an example of a change selection screen for selecting whether to change the display settings.

FIG. 11 illustrates a change selection screen 11000, which is a screen displayed when the information processing apparatus 1004 displays layout data. A NO button 11001 on the change selection screen 11000 is a button to be pressed if the display settings are to not be changed. The user can select to not change the display settings by pressing the NO button 11001. A YES button 11002 is a button to be pressed if the display settings are to be changed. The user can select to change the display settings by pressing the YES button 11002.

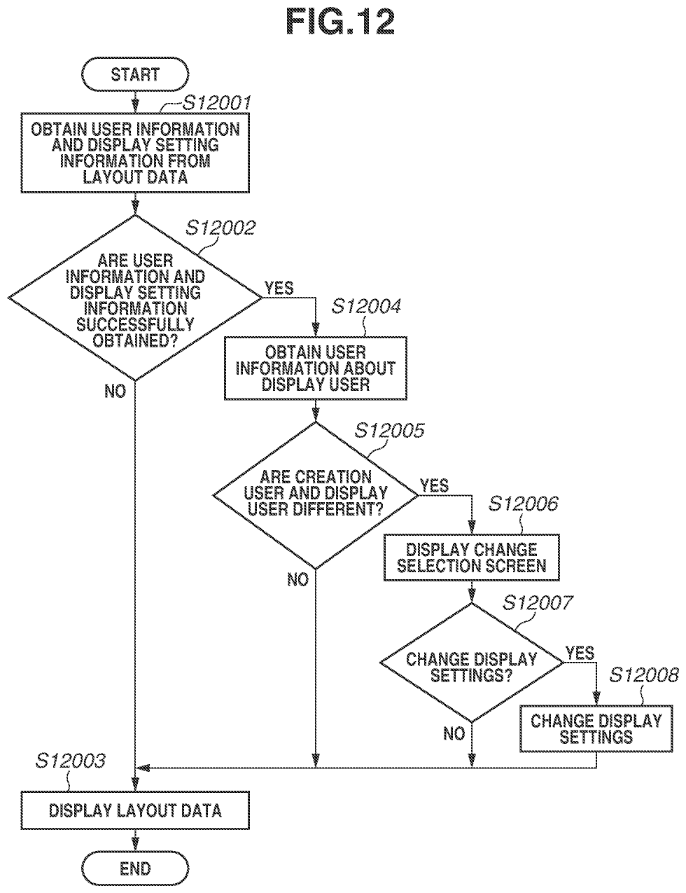

Next, processing for displaying layout data stored in a file will be described with reference to FIG. 12.

FIG. 12 is a flowchart for describing layout data display processing according to the third embodiment. The processing of this flowchart is implemented by the CPU 1011 reading a program stored in the storage device 1008 into the RAM 1010 and executing the program. The CPU 1011 of the information processing apparatus 1004 starts the processing of this flowchart if the open button 7010 of FIG. 7 is pressed and file specification is accepted via the OS's file specification dialog (not illustrated).

Steps S12001 to S12005 of FIG. 12 are similar to steps S9001 to S9005 of FIG. 9. A description thereof will thus be omitted. In the third embodiment, if the creation user and the display user are different (YES in step S12005), the processing proceeds to step S12006.

In step S12006, the information processing apparatus 1004 displays the change selection screen 11000 illustrated in FIG. 11, and accepts user operations performed on the change selection screen 11000. If the information processing apparatus 1004 detects that the user presses the NO button 11001 or the YES button 11002 on the change selection screen 11000 illustrated in FIG. 11, the processing proceeds to step S12007.

In step S12007, the information processing apparatus 1004 determines whether the YES button 11002 is detected to be pressed. If the NO button 11001 is detected to be pressed (NO in step S12007), the processing proceeds to step S12003.

In contrast, if the YES button 11002 is detected to be pressed (YES in step S12007), the processing proceeds to step S12008. Step S12008 is similar to step S9006 of FIG. 9. A description thereof will thus be omitted.

As described above, in the third embodiment, the information processing apparatus 1004 has the display user select whether to change the display settings of the display user to those of the creation user. With such a configuration, if a user different from the creation user displays the editing data, the display user can give priority to his/her own display settings. The display user can recognize that the layout data is created with different display settings, and can recognize the possibility of color changes.

In the foregoing first embodiment, if a user outputs created layout data, another user displays the layout data, and the creation user and the display user are different, the display settings of the display user are adjusted to those of the creation user. The display settings may sometimes be unable to be matched because settable items can be different depending on the types of display devices and the OSes. In a fourth embodiment, a method for notifying the display user if the display settings of the display user are not adjustable to those of the creation user will be described. With such a configuration, if the display settings are unable to be changed, the display user can be notified and can recognize the possibility of color changes. Only differences between the first and fourth embodiments will be described.

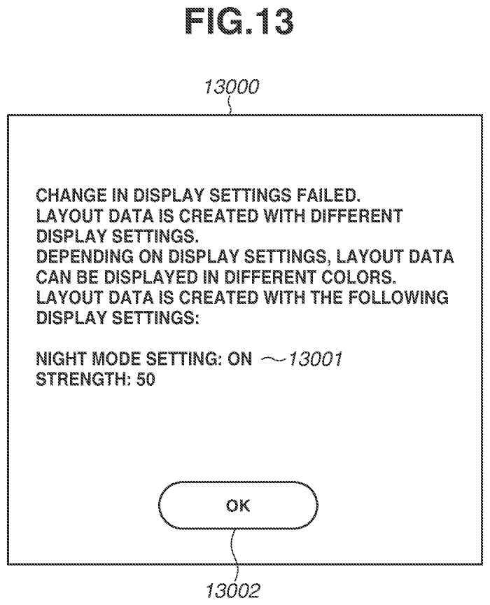

A screen for notifying of a failure in changing the display settings will initially be described with reference to FIG. 13.

FIG. 13 is a diagram illustrating an example of a notification screen for notifying of a failure in changing the display settings.

FIG. 13 illustrates a notification screen 13000, which is a screen to be displayed if the display settings are unable to be changed in displaying layout data. A message 13001 on the notification screen 13000 is intended to notify that the display settings are unable to be changed. The message 13001 is displayed with the display setting information included in the layout data, whereby the display user can be notified what display settings the layout data is created with. An OK button 13002 is a button for closing the notification screen 13000. The user can close the notification screen 13000 by pressing the OK button 13002.

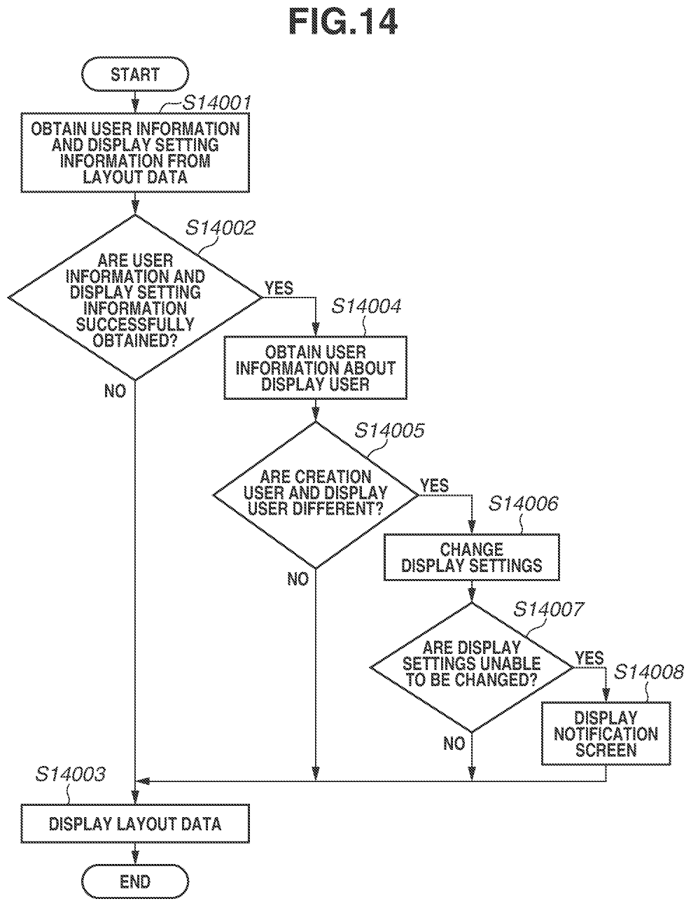

Next, processing for displaying layout data stored in a file will be described with reference to FIG. 14.

FIG. 14 is a flowchart for describing layout data display processing according to the fourth embodiment. The processing of this flowchart is implemented by the CPU 1011 reading a program stored in the storage device 1008 into the RAM 1010 and executing the program. The CPU 1011 of the information processing apparatus 1004 starts the processing of this flowchart if the open button 7010 of FIG. 7 is pressed and file specification is accepted via the OS's file specification dialog (not illustrated).

Steps S14001 to S14006 of FIG. 14 are similar to steps S9001 to S9006 of FIG. 9. A description thereof will thus be omitted. In the fourth embodiment, after step S14006, the processing proceeds to step S14007.

In step S14007, the information processing apparatus 1004 determines whether the display settings are unable to be changed by the processing for changing the display settings, performed in step S14006. If the display settings are determined to be successfully changed (NO in step S14007), the processing proceeds to step S14003.

In contrast, if the display settings are determined to not be successfully changed (change is failed) (YES in step S14007), the processing proceeds to step S14008. For example, in step S14006, the information processing apparatus 1004 makes the display settings on the OS. If the OS settings are not normally completed, the information processing apparatus 1004 determines that the processing for changing the display settings is failed (display settings are not successfully changed).

In step S14008, the information processing apparatus 1004 displays the notification screen 13000 of FIG. 8. The message 13001 displayed on the notification screen 13000 includes the display setting information included in the layout data. In the example illustrated in FIG. 13, the display settings included in the layout data indicate that the night mode setting is ON and the strength of the blue light reduction is 50. This message 13001 can inform the display user of the possibility of color changes due to a failure in changing the display settings, and the display settings of the creation user.

As described above, according to the fourth embodiment, the display user is notified if the display setting of the display user are unable to be adjusted to those of the creation user. With such a configuration, if the display settings are unable to be changed, the display user can be informed of it and can recognize the possibility of color changes.

In the foregoing first embodiment, if a user outputs created layout data, another user displays the layout data, and the creation user and the display user are different, the display settings of the display user are adjusted to those of the creation user. Depending on the created layout data, color can be unchanged regardless of the display settings. In such a case, the display settings of the display user do not necessarily need to be adjusted to those of the creation user. In a fifth embodiment, a method by which the creation user, when creating layout data, presets whether to change the display settings during display. With such a configuration, the display user can display the layout data while maintaining his/her own display settings if color does not change and the display settings do not need to be changed. Only differences between the first and fifth embodiments will be described.

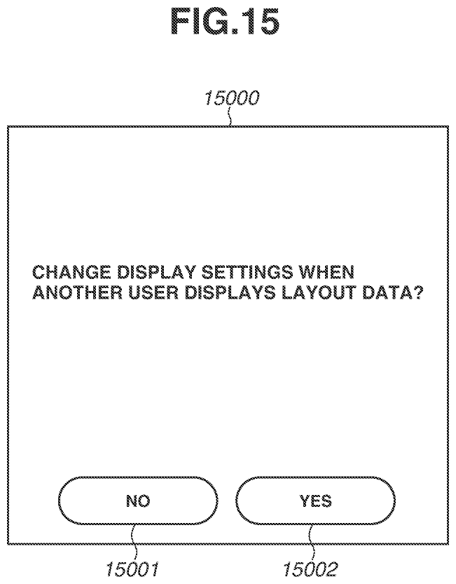

A screen for presetting whether to change the display settings during display will initially be described with reference to FIG. 15.

FIG. 15 is a diagram illustrating an example of a change presetting screen for presetting whether to change the display settings during display.

FIG. 15 illustrates a change presetting screen 15000, which is a screen displayed when layout data is created on the information processing apparatus 1004. A NO button 15001 on the change presetting screen 15000 is a button to be pressed if the display settings are set to not be changed. The creation user can make a setting to not change the display settings by pressing the NO button 15001. A YES button 15002 is a button to be pressed if the display settings are set to be changed. The creation user can make a setting to change the display settings by pressing the YES button 15002.

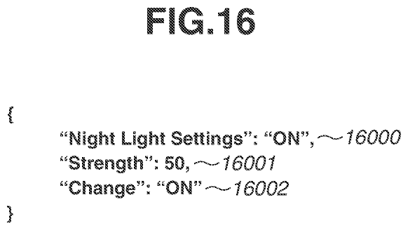

Next, a configuration of a file describing the display setting information will be described with reference to FIG. 16.

FIG. 16 is a diagram illustrating an example of the file describing the display setting information in creating layout data according to the fifth embodiment. In the present embodiment, the file describing the display setting information is a file with an extension json, for example, and described in JSON.

Keys 16000 and 16001 of FIG. 16 are similar to the keys 5000 and 5001 of FIG. 5. A description thereof will thus be omitted. A key 16002 “Change” describes whether to change the display settings (hereinafter, change presetting).

As illustrated in FIG. 15, the creation user presets whether to change the display settings on the change presetting screen 15000. In the example of FIG. 16, the key 16002 “Change” has a value “ON”, which indicates that the display settings are set to be changed.

### Layout Data Storage Processing

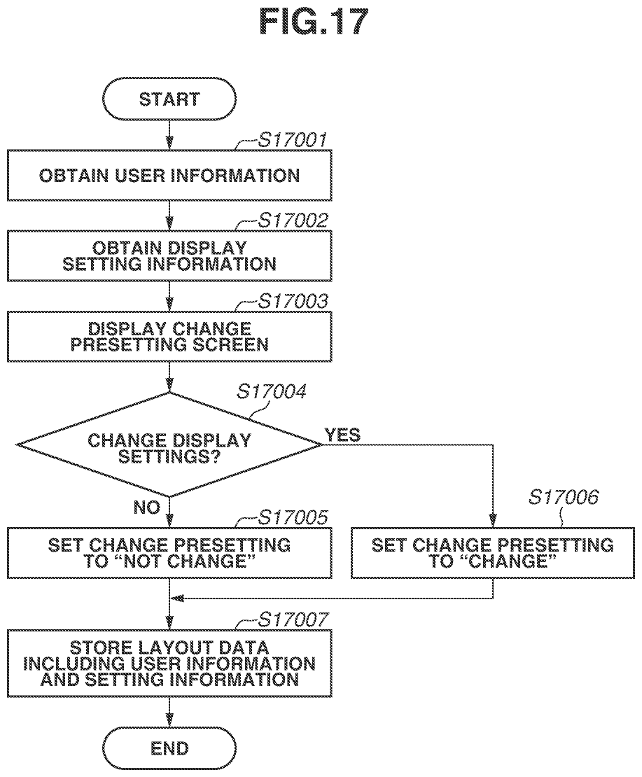

Next, processing for storing the layout data will be described with reference to FIG. 17.

FIG. 17 is a flowchart for describing layout data storage processing according to the fifth embodiment. The processing of this flowchart is implemented by the CPU 1011 reading a program stored in the storage device 1008 into the RAM 1010 and executing the program. The CPU 1011 of the information processing apparatus 1004 starts the processing of this flowchart if the save button 7009 of FIG. 7 is detected to be pressed.

Steps S17001 and S17002 of FIG. 17 are similar to steps S8001 and S8002 of FIG. 8. A description thereof will thus be omitted. In the fifth embodiment, after step S17002, the processing proceeds to step S17003. In step S17003, the information processing apparatus 1004 displays the change presetting screen 15000 illustrated in FIG. 15, and accepts user operations on the change presetting screen 15000. If user operations are accepted and the information processing apparatus 1004 detects that the user presses the NO button 15001 or the YES button 15002 on the change presetting screen 15000, the processing proceeds to step S17004.

In step S17004, the information processing apparatus 1004 determines whether the YES button 15002 is detected to be pressed. If the NO button 15001 is detected to be pressed (NO in step S17004), the processing proceeds to step S17005.

In step S17005, the information processing apparatus 1004 determines to set the change presetting to “not change”. The processing proceeds to step S17007.

In contrast, if the YES button 15002 is detected to be pressed (YES in step S17004), the processing proceeds to step S17006.

In step S17006, the information processing apparatus 1004 determines to set the change presetting to “change”. The processing proceeds to step S17007.

In step S17007, the information processing apparatus 1004 includes the user information and the display setting information about the user who creates the layout data into the layout data, and stores the layout data. Details will now be described.

The information processing apparatus 1004 initially generates a file describing the user information such as illustrated in FIG. 6 based on the user information obtained in step S17001.

Next, the information processing apparatus 1004 generates a file describing the display setting information such as illustrated in FIG. 16 based on the display setting information obtained in step S17002 and the change presetting determined in step S17005 or S17006. For example, if the change presetting is determined to be “not change” in step S17005, the information processing apparatus 1004 generates a file DisplaySettings.json described in JSON so that the key “Change” has a value “OFF”. In contrast, if the change presetting is determined to be “change” in step S17006, the information processing apparatus 1004 generates a file DisplaySettings.json described in JSON so that the key “Change” has a value “ON” as illustrated in FIG. 16.

The information processing apparatus 1004 then stores the layout data created by the user on the editing screen such as illustrated in FIG. 7 into a file Poster.cpfx3 as the layout data illustrated in FIG. 4. Here, the information processing apparatus 1004 includes the file UserInfo.json (file 4006 in FIG. 4) and the file DisplaySettings.json (file 4005 in FIG. 4) into the file Poster.cpfx3.

### Layout Data Display Processing

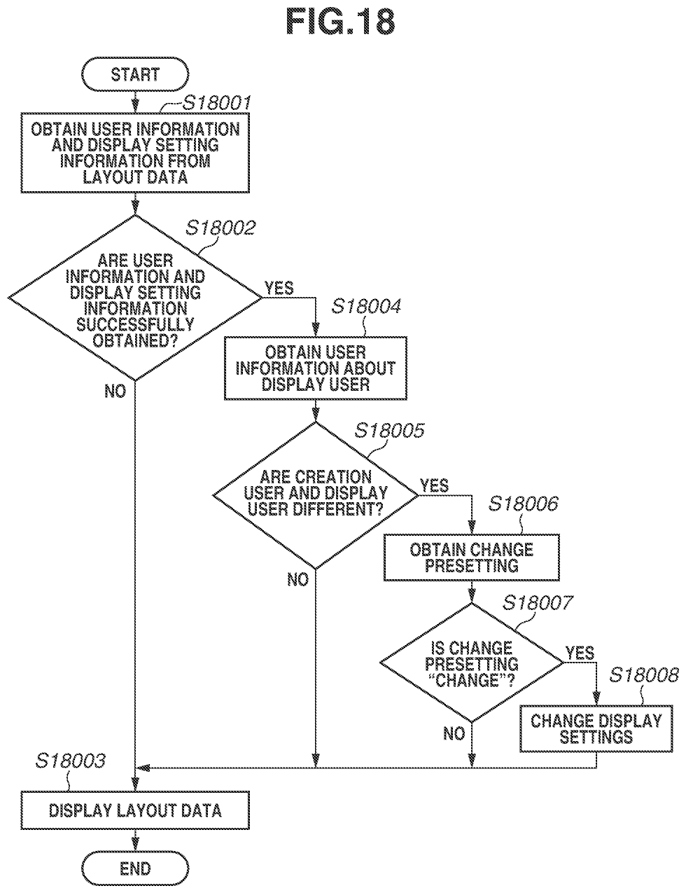

Next, processing for displaying the layout data stored in the file will be described with reference to FIG. 18.

FIG. 18 is a flowchart for describing layout data display processing according to the fifth embodiment. The processing of this flowchart is implemented by the CPU 1011 reading a program stored in the storage device 1008 into the RAM 1010 and executing the program. The CPU 1011 of the information processing apparatus 1004 starts the processing of this flowchart if the open button 7010 of FIG. 7 is pressed and file specification is accepted via the OS's file specification dialog (not illustrated).

Steps S18001 to S18005 of FIG. 18 are similar to steps S9001 to S9005 of FIG. 9. A description thereof will thus be omitted. In the fifth embodiment, if the creation user and the display user are different (YES in step S18005), the processing proceeds to step S18006.

In step S18006, the information processing apparatus 1004 obtains the change presetting included in the display setting information obtained from the layout data in step S18001. For example, if the file DisplaySettings.json describing the display setting information has the content illustrated in FIG. 16, the information processing apparatus 1004 obtains the value corresponding to the key “Change” as the change presetting.

In step S18007, the information processing apparatus 1004 determines whether the change presetting is “change”. If the value corresponding to the key “Change” serving as the change presetting is “ON”, the change presetting is determined to be “change”. If the value corresponding to the key “Change” is “OFF”, the change presetting is determined to be “not change”.

If the change presetting is “not change” (NO in step S18007), the processing proceeds to step S18003 without changing the display settings.

In contrast, if the change presetting is “change” (YES in step S18007), the processing proceeds to step S18008. Step S18008 is similar to step S9006 of FIG. 9. A description thereof will thus be omitted.

As described above, in the fifth embodiment, the method by which the creation user, when creating layout data, presets whether to change the display settings during display has been described. With such a configuration, the display user can display the layout data while maintaining his/her own display settings if color does not change and the display settings do not need to be changed.

In the foregoing first embodiment, if a user outputs created layout data, another user displays the layout data, and the creation user and the display user are different, the display settings of the display user are adjusted to those of the creation user. While it is important to prevent color changes due to the display settings, not all users necessarily put a premium on color nor do the display settings of all display users need to be adjusted to those of the creation user. In a sixth embodiment, a method by which the creation user, when creating layout data, makes presetting to change the display settings in a case where a specific display user displays the layout data. With such a configuration, the display settings of the specific display user can be changed to provide display under the same condition as with the creation user, and reduce color changes due to the display settings. Only differences between the first and sixth embodiments will be described.

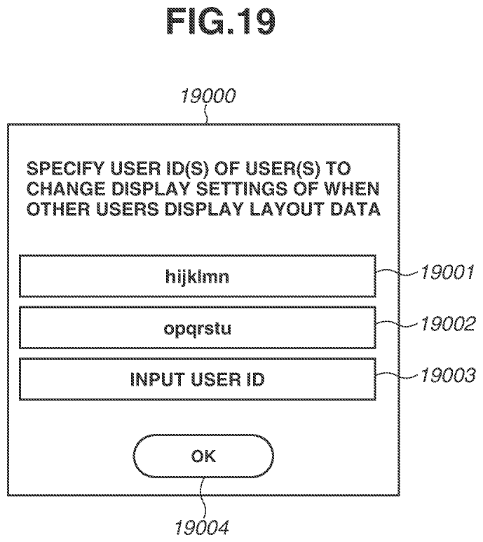

A screen for presetting a user or users to change the display settings of during display will initially be described with reference to FIG. 19.

FIG. 19 is a display user setting screen for presetting the user(s) to change the display settings of during display.

FIG. 19 illustrates a display user setting screen 19000, which is a screen displayed in creating layout data on the information processing apparatus 1004. User ID input sections 19001 to 19003 on the display user setting screen 19000 are intended to input the user IDs of users to change the display settings of. The creation user inputs the user IDs of users to change the display settings of into the user ID input sections 19001 to 19003. In the example of FIG. 19, a user ID “hijklmn” is input to the user ID input section 19001, and a user ID “opqrstu” is input to the user ID input section 19002. The user ID input section 19003 indicates that no user ID is input. An OK button 19004 is a button to be pressed when the input of the user IDs is completed. The creation user can set the user IDs of the users to change the display settings of by pressing the OK button 19004.

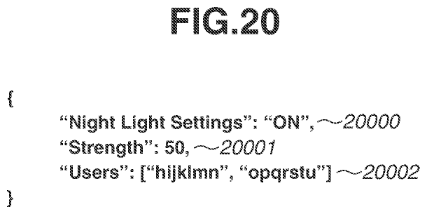

Next, a configuration of a file describing display setting information will be described with reference to FIG. 20.

FIG. 20 is a diagram illustrating an example of the file describing the display setting information in creating layout data. In the present embodiment, the file describing the display setting information is a file with an extension json, for example, and described in JSON.

Keys 20000 and 20001 of FIG. 20 are similar to the keys 5000 and 5001 of FIG. 5. A description thereof will thus be omitted. A key 20002 “Users” described the user IDs of the users to change the display settings of. As illustrated in FIG. 19, the creation user presets the user IDs of the users to change the display settings of on the display user setting screen 19000. In the example of FIG. 20, the key 20002 “Users” has a value [“hijklmn”, “opqrstu”], which indicates that the user IDs of the users to change the display settings of are “hijklmn” and “opqrstu”.

### Layout Data Storage Processing

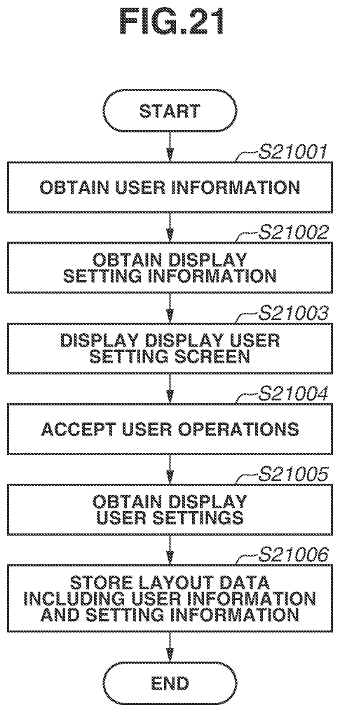

Next, processing for storing the layout data will be described with reference to FIG. 21.

FIG. 21 is a flowchart for describing layout data storage processing according to the sixth embodiment. The processing of this flowchart is implemented by the CPU 1011 reading a program stored in the storage device 1008 into the RAM 1010 and executing the program. The CPU 1011 of the information processing apparatus 1004 starts the processing of this flowchart if the save button 7009 of FIG. 7 is detected to be pressed.

Steps S21001 and S21002 of FIG. 21 are similar to steps S8001 and S8002 of FIG. 8. A description thereof will thus be omitted. In the sixth embodiment, the processing proceeds to step S21003 after step S21002. In step S21003, the information processing apparatus 1004 displays the display user setting screen 19000 illustrated in FIG. 19.

In step S21004, the information processing apparatus 1004 accepts user operations on the display user setting screen 19000. If the information processing apparatus 1004 detects that the user presses the OK button 19004 on the display user setting screen 19000, the processing proceeds to step S21005.

In step S21005, the information processing apparatus 1004 obtains the user IDs input to the user ID input sections 19001 to 19003 of the display user setting screen 19000 as the settings of the users to change the display settings of (hereinafter, display user settings). In the example of FIG. 19, the information processing apparatus 1004 obtains the user IDs “hijklmn” and “opqrstu” as the display user settings.

In step S21006, the information processing apparatus 1004 includes the user information and the display setting information about the user who creates the layout data into the layout data, and stores the layout data. Details will now be described.

The information processing apparatus 1004 initially generates a file describing the user information such as illustrated in FIG. 6 based on the user information obtained in step S21001.

The information processing apparatus 1004 then generates a file describing the display setting information such as illustrated in FIG. 20 based on the display setting information obtained in step S21002 and the display user settings obtained in step S21005. For example, if the user IDs “hijklmn” and “opqrstu” are obtained as the display user settings in step S21005, the information processing apparatus 1004 generates a file DisplaySettings.json described in JSON such that the key “Users” has a value [“hijklmn”, “opqrstu”].

The information processing apparatus 1004 then stores the layout data created by the user on the editing screen such as illustrated in FIG. 7 into a file Poster.cpfx3 as the layout data such as illustrated in FIG. 4. Here, the information processing apparatus 1004 includes the file UserInfo.json (file 4006 in FIG. 4) and the file DisplaySettings.json (file 4005 in FIG. 4) into the file Poster.cpfx3.

### Layout Data Display Processing

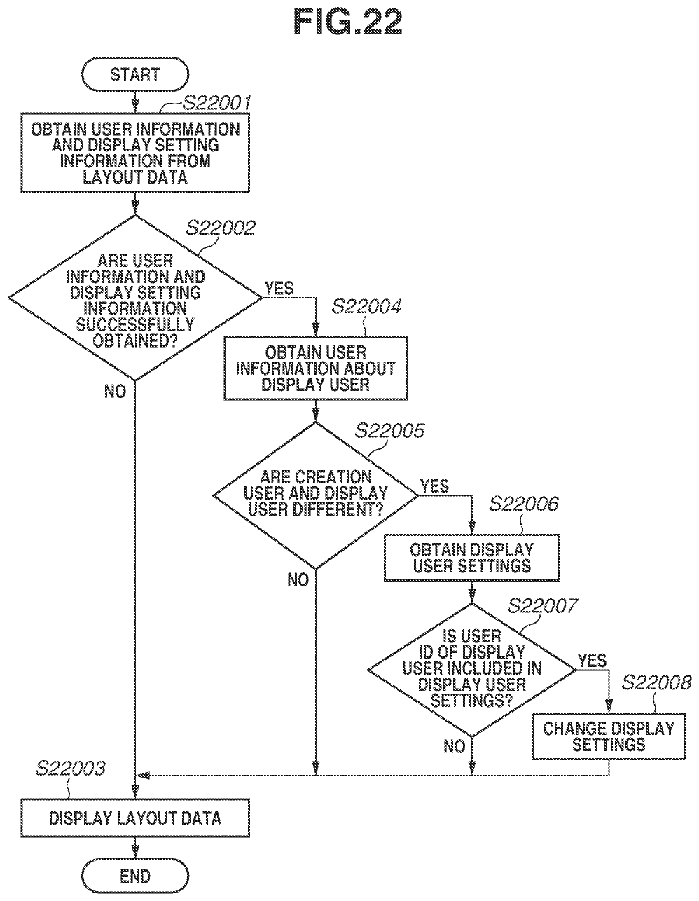

Processing for displaying the layout data stored in the file will now be described with reference to FIG. 22.

FIG. 22 is a flowchart for describing layout data display processing according to the sixth embodiment. The processing of this flowchart is implemented by the CPU 1011 reading a program stored in the storage device 1008 into the RAM 1010 and executing the program. The CPU 1011 of the information processing apparatus 1004 starts the processing of this flowchart if the open button 7010 of FIG. 7 is pressed and file specification is accepted via the OS's file specification dialog (not illustrated).

Steps S22001 to S22005 of FIG. 22 are similar to steps S9001 to S9005 of FIG. 9. A description thereof will thus be omitted. In the sixth embodiment, if the creation user and the display user are different (YES in step S22005), the processing proceeds to step S22006.

In step S22006, the information processing apparatus 1004 obtains the display user settings included in the display setting information obtained from the layout data in step S22001. For example, if the file DisplaySettings.json describing the display user settings has the content illustrated in FIG. 20, the information processing apparatus 1004 obtains the value corresponding to the key “Users” as the display user settings. In the example of FIG. 20, the information processing apparatus 1004 obtains [“hijklmn”, “opqrstu”] as the value of the key “Users”.

In step S22007, the information processing apparatus 1004 determines whether the user ID of the display user obtained in step S22001 is included in the display user settings obtained in step S22006.

If the user ID of the display user is not included in the display user settings obtained in step S22006 (NO in step S22007), the processing proceeds to step S22003 without changing the display settings.

In contrast, if the user ID of the display user is included in the display user settings obtained in step S22006 (YES in step S22007), the processing proceeds to step S22008. For example, if the user ID of the display user is “hijklmn” and the display user settings are [“hijklmn”, “opqrstu”], the user ID of the display user is determined to be included in the display user settings. Step S22008 is similar to step S9006 of FIG. 9. A description thereof will thus be omitted.

As described above, in the sixth embodiment, the creation user, when creating layout data, makes presetting to change the display settings if a specific display user displays the layout data. With such a configuration, the display settings of the specific display user can be changed to provide display under the same condition, and color changes due to the display settings can be reduced.

In the foregoing first embodiment, if a user outputs created layout data, another user displays the layout data, and the creation user and the display user are different, the display settings of the display user are adjusted to those of the creation user. As a result, the user who displays the created layout data can reduce color changes caused by changing the display settings. In contrast, if the display user ends the display of the layout data, the display settings set by the display user himself/herself before are desirably restored. In a seventh embodiment, a method for restoring the display settings set by the display user before if the display user ends the display of the layout data will be described. With such a configuration, the display settings of the display user can be changed to provide display under the same condition, and color changes occurring due to the display settings can be reduced. In addition, when the display is ended, the display settings set by the display user himself/herself before can be restored. Only differences between the first and seventh embodiments will be described.

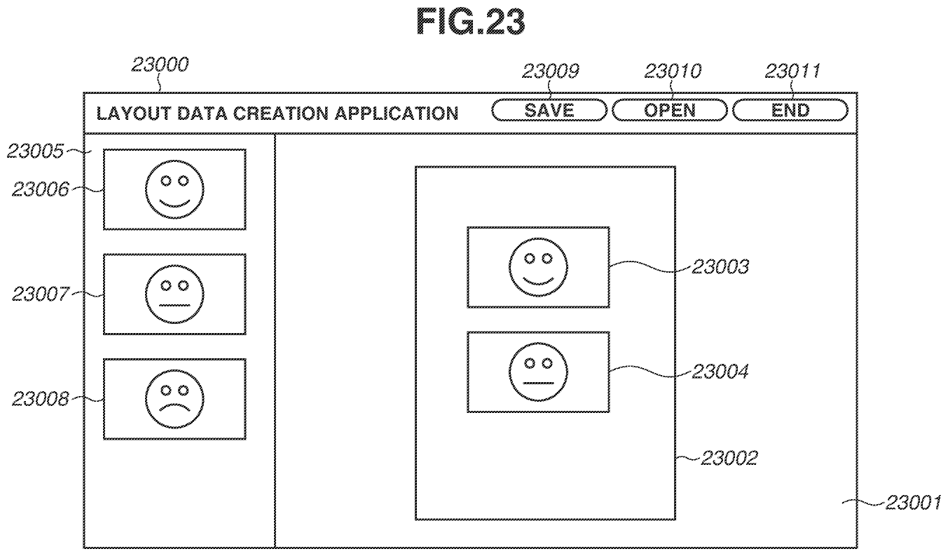

A screen for creating, editing, and displaying layout data will initially be described with reference to FIG. 23.

FIG. 23 is a diagram illustrating an example of the screen displayed to create, edit, and display layout data according to the seventh embodiment.

Items 23000 to 23010 of FIG. 23 are similar to the items 7000 to 7010 of FIG. 7. A description thereof will thus be omitted. An end button 23001 is a button for ending the display of the layout data. If the user presses the end button 23011, the information processing apparatus 1004 closes the editing screen 23000 and ends the display of the layout data.

### Layout Data Display Processing

Processing for displaying the layout data stored in a file will now be described.

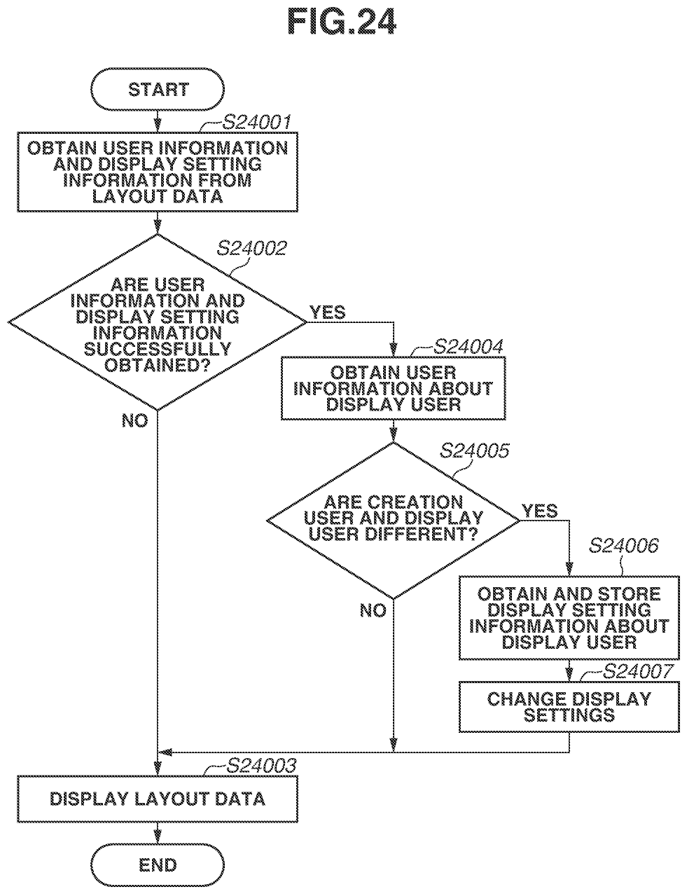

FIG. 24 is a flowchart for describing layout data display processing according to the seventh embodiment. The processing of this flowchart is implemented by the CPU 1011 reading a program stored in the storage device 1008 into the RAM 1010 and executing the program. The CPU 1011 of the information processing apparatus 1004 starts the processing of this flowchart if the open button 7010 of FIG. 7 is pressed and file specification is accepted via the OS's file specification dialog (not illustrated).

Steps S24001 to S24005 of FIG. 24 are similar to steps S9001 to S9005 of FIG. 9. A description thereof will thus be omitted. In the seventh embodiment, if the creation user and the display user are different (YES in step S24005), the processing proceeds to step S24006.

In step S24006, the information processing apparatus 1004 obtains the display setting information about the display user and stores the display setting information into the RAM 1010 or the storage device 1008. For example, the user can set the display setting information into the information processing apparatus 1004 from the display setting screen 3000 illustrated in FIG. 3A. This display setting information is obtained in the processing of the foregoing step S8002. If, for example, the display settings are set as illustrated in FIG. 3B, then in step S24006, the information processing apparatus 1004 obtains and stores the night mode setting “ON” and the strength of blue light reduction “50” as the display setting information.

Step S24007 is similar to step S9006 of FIG. 9. A description thereof will thus be omitted.

### Layout Data Display End Processing

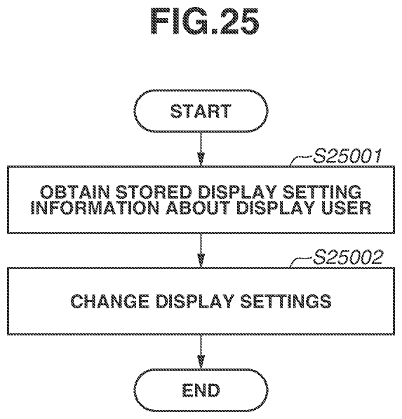

Next, processing for ending the display of the layout data will be described with reference to FIG. 25.

FIG. 25 is a flowchart for describing layout data display end processing according to the seventh embodiment. The processing of this flowchart is implemented by the CPU 1011 reading a program stored in the storage device 1008 into the RAM 1010 and executing the program. The CPU 1011 of the information processing apparatus 1004 starts the processing of this flowchart if the end button 23011 of FIG. 23 is pressed to close the editing screen 23000 and a request to end the display of the layout data is accepted.

In step S25001, the information processing apparatus 1004 obtains the display setting information about the display user, stored in the RAM 1010 or the storage device 1008 in step S24006 of FIG. 24 (i.e., the display setting information yet to be changed in step S24007 of FIG. 24).

In step S25002, the information processing apparatus 1004 changes the display settings based on the display setting information about the display user, obtained in the foregoing step S25001. This processing is similar to that of step S9006 of FIG. 9. A detailed description thereof will thus be omitted.

In the foregoing description, the layout data display end processing of FIG. 25 is described to be started if the end button 23011 of FIG. 23 is pressed. However, the CPU 1011 of the information processing apparatus 1004 can be configured to detect the closing of the editing screen 23000 and start the layout data display end processing of FIG. 25 without the end button 23011 being pressed.

As described above, in the seventh embodiment, the display settings set by the display user before are restored if the display user ends the display of the layout data. With such a configuration, the display settings of the display user can be changed to provide display under the same condition, and color changes due to the display settings can be reduced. In addition, if the display is ended, the display settings set by the display user himself/herself before can be restored.

The seventh embodiment can also be applied if the display settings are changed in the second to sixth embodiments, not just the first embodiment.

In the foregoing embodiments, a layout data creation application has been described as an example of the application. However, this is not restrictive. The embodiments can be implemented with and are effective for any application having a similar image layout function.

In the foregoing embodiments, a personal computer is assumed as the information processing apparatus. However, this is not restrictive. The embodiments can be implemented with and are effective for any information processing apparatus (terminal) capable of similar usage. Examples may include a mobile phone, a portable information terminal, a digital still camera, a digital video camera, a portable music player, a game machine, a set-top box, and Internet home appliances.

In the foregoing embodiments, the network can have any network configurations, such as a wireless local area network (LAN), the Institute of Electrical and Electronics Engineers (IEEE) 1394, and Bluetooth®.

It will be understood that the configurations and content of various types of data described above are not restrictive, and various configurations and content can be employed depending on the uses and purposes.

While several embodiments have been described above, embodiments of the present disclosure can be practiced in forms such as a system, an apparatus, a method, a program, and a storage medium. Specifically, an embodiment of the present disclosure can be applied to a system including a plurality of devices, or an apparatus having a single device.

Configurations combining the foregoing embodiments are all included in the present disclosure.

While the embodiments of the present disclosure have been described in detail above, the present disclosure is not limited to specific embodiments, and various changes and modifications can be made without departing from the gist of the present disclosure set forth in the claims.

An embodiment of the present disclosure can also be implemented by processing for supplying a program for implementing one or more functions of the foregoing embodiments to a system or an apparatus via a network or a storage medium, and reading and executing the program by one or more processors in a computer of the system or apparatus. A circuit for implementing one or more functions (for example, application-specific integrated circuit [ASIC]) can also be used for implementation.

An embodiment of the present disclosure can be applied to a system including a plurality of devices, or an apparatus having a single device.

The present disclosure is not limited to the foregoing embodiments. Various modifications (including organic combinations of the embodiments) can be made based on the gist of the present disclosure, and such modifications are not excluded from the scope of the present disclosure. In other words, configurations combining the foregoing embodiments and modifications thereof are all included in the present disclosure.

According to an embodiment of the present disclosure, content data such as layout data can be easily displayed with the same display settings as when the content data is created. This can facilitate appropriate color check of the content data.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of priority from Japanese Patent Application No. 2023-002115, filed Jan. 11, 2023, which is hereby incorporated by reference herein in its entirety.

What is claimed is:

1. A control method comprising:
generating content data to include display setting information, wherein the content data is generated by an information processing apparatus and the display setting information being setting information about a display of the information processing apparatus; and
displaying the content data based on the display setting information corresponding to the content data.

2. The control method according to claim 1, wherein the content data is layout data on one or a plurality of images to be laid out on a plane of paper.

3. The control method according to claim 1, wherein a setting related to the display of the information processing apparatus is changed to a same setting as a setting of the display setting information corresponding to the content data.

4. The control method according to claim 1, wherein a setting related to display of an area where the content data is displayed is changed, and a setting related to display of an area where the content data is not displayed is not changed.

5. The control method according to claim 1, wherein a user operation for selecting whether to change a setting related to the display is accepted, and the setting related to the display is changed based on selection to change the setting related to the display being made by the user operation.

6. The control method according to claim 1, further comprising, if a change in a setting related to the display fails, displaying a message indicating a failure in changing the setting related to the display.

7. The control method according to claim 1, further comprising:
accepting a user operation for making presetting as to whether to change a setting related to the display in displaying the content data, and including the presetting made by the user operation into the content data; and
if the presetting included in the content data is to change the setting related to the display, controlling a change of the setting related to the display.

8. The control method according to claim 1, further comprising:
accepting a user operation for making presetting as to whether to change a setting related to the display in displaying the content data, and including the presetting made by the user operation into the content data; and
if user information included in the presetting included in the content data and user information about a user requesting display of the content data are same, controlling a change of the setting related to the display.

9. The control method according to claim 1, further comprising:
storing, in a storage unit, a setting related to the display before changing the setting; and
in ending display of the content data, changing the setting related to the display of the information processing apparatus based on the setting, stored in the storage unit.

10. The control method according to claim 1, wherein the display setting information is information about a setting of a display unit to reduce blue light, the display unit being configured to display the content data.

11. The control method according to claim 1, wherein the display setting information is information about a setting indicating a color space set in a display unit configured to display the content data.

12. The control method according to claim 1, wherein the display setting information is information about a model of a display unit configured to display the content data.

13. The control method according to claim 1, wherein the display setting information is setting information about an operating system (OS) of the information processing apparatus.

14. The control method according to claim 1, wherein the display setting information is a display setting used by a plurality of applications for a general purpose.

15. A device comprising: at least one memory device that stores a set of instructions; and at least one processor that executes the set of instructions, the instructions, when executed, causing the device to perform operations comprising:
generating content data to include display setting information, wherein the content data is generated by an information processing apparatus and the display setting information being setting information about a display of the information processing apparatus; and
displaying the content data based on the display setting information corresponding to the content data.

16. A non-transitory computer-readable storage medium storing computer-executable code of a program for a control method executed by a processor in a system, the computer-executable code comprising code to execute:
generating content data to include display setting information, wherein the content data is generated by an information processing apparatus and the display setting information being setting information about a display of the information processing apparatus; and
displaying the content data based on the display setting information corresponding to the content data.
